(19) United States
(12) Patent Application Publication
(10) Pub. No.: US 2024/0319712 A1
(43) Pub. Date: Sep. 26, 2024

(54) Dynamic Range-Aware Conversion of Sensor Readings

(71) Applicants: Advanced Micro Devices, Inc, Santa Clara, CA (US); ATI Technologies ULC, Markham (CA)

(72) Inventors: Jerry Anton Ahrens, Sister Bay, WI (US); Grant Evan Ley, Eden, UT (US); Anil Harwani, Austin, TX (US); Amitabh Mehra, Fort Collins, CO (US); Joshua Taylor Knight, Georgetown, TX (US); William Robert Alverson, Del Valle, TX (US); Adam Neil Calder Clark, Victoria (CA)

(21) Appl. No.: 18/187,848

(22) Filed: Mar. 22, 2023

(51) Int. Cl. G05B 19/4155; G01K 7/01

(52) U.S. Cl. CPC G05B 19/4155; G01K 7/01; G05B 2219/49216

(57) ABSTRACT

Dynamic range aware conversion of sensor readings is described. A system includes one or more sensors to sense conditions of a component and output sensor readings and a system manager. The system manager is configured to convert the sensor readings into condition measurements by converting the sensor readings into the condition measurements using a first transformation while operating in a first conversion mode or converting the sensor readings into the condition measurements using a second transformation while operating in a second conversion mode. The system manager then adjusts operation of the component based on the condition measurements.

### BACKGROUND

Typically, computing systems have a discreet number of sensors (e.g., thermal diodes) to sense one or more conditions of portions of a computing system, e.g., of one or more components of the computing system. Further, the system may use the sensed conditions to control operation of the computing system.

### BRIEF DESCRIPTION OF THE DRAWINGS

FIG. 1 is a block diagram of a non-limiting example system having a system manager that is operable to implement dynamic range aware scaling of sensor readings.

FIG. 2 is a block diagram of a non-limiting example in which sensor readings from a temperature sensor are converted dynamically based on first and second temperature ranges.

FIG. 3 depicts a procedure in an example implementation of dynamic range aware conversion of sensor readings.

FIG. 4 depicts a procedure in an example implementation of dynamic temperature range aware conversion of sensor readings.

### DETAILED DESCRIPTION

### Overview

In conventional approaches, system managers limit the condition measurements that are produced from sensor readings. By default for example, some conventional systems limit the temperature measurements that are produced from the output of thermal diodes (e.g., temperature sensors) to a range of approximately −49 degrees Celsius to 125 degrees Celsius. This is at least partially because those sensors lack the fidelity to produce sensor readings that are as accurate for relatively low temperatures (e.g., −150 degrees Celsius) as they are for higher temperatures. For example, at very low temperatures the voltage readings produced by thermal diodes can correspond to small values (numerous leading zeroes) which can change significantly due to relatively minor fluctuations in temperature. Due to this, conventional systems simply “cap” measurements below a lower threshold of a default range, e.g., −49 degrees Celsius. Those conventional systems treat temperatures below the cap in a same manner. For instance, conventional systems that are capped at −49 degrees Celsius handle system adjustments for −50 degrees Celsius and −150 degrees Celsius the same way. By way of example, these conventional systems adjust component operating parameters (e.g., voltage, frequency, timings, etc.) the same way at −50 degrees Celsius and at −150 degrees Celsius. Without adjusting operation of the components differently at different temperatures outside the default range, conventional approaches fail to take advantage of performance improvements or optimizations which would be available if the operation of those components were adjusted based on the actual temperatures.

To solve these problems, dynamic range-aware conversion of sensor readings is described. In accordance with the described techniques, a system manager is configured to convert sensor readings (e.g., voltages) received from a sensor (e.g., a thermal diode) of a system into condition measurements using different transformations while operating in different modes associated with different conditions. By way of example, the system manager converts the sensor readings to condition measurements using a first transformation (e.g., algorithm) for a first range (e.g., a default range) of the condition measurements. The condition measurements produced by the conversion component based on the first transformation have a first granularity. As an example, the condition measurements produced based on the first transformation measure the condition out to two decimal places of a unit. For a second range of the condition measurements, the conversion component converts the sensor readings to condition measurements using a second transformation (e.g., algorithm). The condition measurements produced by the conversion component based on the second transformation have a second granularity.

In one or more implementations, the second granularity associated with the second mode is less granular than the first granularity associated with the first mode. With reference to temperature measurements, for instance, the sensor readings received from a thermal diode are converted into temperature measurements using a first granularity while operating in a first conversion mode, and sensor readings received from the thermal diode are converted into temperature measurements using a second granularity while operating in a second conversion mode. By way of example, the system manager uses the first granularity while operating in a first conversion mode that is associated with a first temperature range (e.g., approximately −49 degrees Celsius to approximately 125 degrees Celsius) and uses the second granularity (which is less granular than the first granularity) while operating in a second conversion mode that is associated with a second temperature range (e.g., approximately −273 degrees Celsius to approximately −49 degrees Celsius).

Thus, in contrast to conventional techniques, the system manager does not treat all condition measurements (e.g., temperatures) outside a default range in a same manner. In at least one variation, for instance, the system manager 104 does not handle system adjustments for −50 degrees Celsius and −150 degrees Celsius the same way. Rather than cap the condition measurements at the bounds of a default range, in one or more implementations, the conversion component converts the sensor readings differently when the condition measurements are outside (e.g., below) a default range. In this way, the described techniques are able to adjust operation of components differently at different temperatures outside the default range which results in performance improvements and optimizations over conventional systems.

In some aspects, the techniques described herein relate to a system including: one or more sensors to sense conditions of a component and output sensor readings, and a system manager to: convert the sensor readings into condition measurements by converting the sensor readings into the condition measurements using a first transformation while operating in a first conversion mode or converting the sensor readings into the condition measurements using a second transformation while operating in a second conversion mode, and adjust operation of the component based on the condition measurements.

In some aspects, the techniques described herein relate to a system, wherein the one or more sensors include one or more thermal diodes.

In some aspects, the techniques described herein relate to a system, wherein the condition measurements are temperature measurements.

In some aspects, the techniques described herein relate to a system, wherein the first mode is associated with a temperature range of −49 degrees Celsius to 125 degrees Celsius and wherein the second mode is associated with a temperature range of −273 degrees Celsius to −49 degrees Celsius.

In some aspects, the techniques described herein relate to a system, wherein the first mode is associated with the condition measurements being above a condition threshold, and wherein the second mode is associated with the condition measurements being below the condition threshold.

In some aspects, the techniques described herein relate to a system, wherein the condition measurements produced based on the first transformation have a first granularity, and wherein the condition measurements produced using the second transformation have a second granularity that is different than the first granularity.

In some aspects, the techniques described herein relate to a system, wherein the second granularity is less granular than the first granularity.

In some aspects, the techniques described herein relate to a system, wherein the condition measurements are one of: humidity measurements; light measurements; barometric-pressure measurements; vibration measurements; decibel measurements; air flow rate measurements; or fluid flow rate measurements.

In some aspects, the techniques described herein relate to an apparatus including: a component, a temperature sensor, and a system manager to: convert voltage readings received from the temperature sensor into temperature measurements using a first transformation while operating in a first conversion mode associated with a first temperature range; switch to a second conversion mode associated with a second temperature range responsive to detecting that the temperature measurements are below a threshold temperature measurement, convert voltage readings received from the temperature sensor into temperature measurements using a second transformation while operating in a second conversion mode associated with a second temperature range, and adjust operation of the component based on the temperature measurements.

In some aspects, the techniques described herein relate to an apparatus, wherein the first transformation and the second transformation cause the system manager to produce temperature measurements having different granularities.

In some aspects, the techniques described herein relate to an apparatus, wherein the temperature measurements produced while operating in the second conversion mode are less granular than the temperature measurements produced while operating in the first conversion mode.

In some aspects, the techniques described herein relate to an apparatus, wherein the temperature sensor includes a thermal diode.

In some aspects, the techniques described herein relate to a method including: receiving sensor readings from a sensor associated with a component, converting the sensor readings into condition measurements, wherein the converting includes converting the sensor readings into the condition measurements using a first transformation while operating in a first conversion mode or converting the sensor readings into the condition measurements using a second transformation while operating in a second conversion mode, and adjusting operation of the component based on the condition measurements.

In some aspects, the techniques described herein relate to a method, wherein the sensor is a thermal diode.

In some aspects, the techniques described herein relate to a method, wherein the condition measurements are temperature measurements.

In some aspects, the techniques described herein relate to a method, wherein the first mode is associated with a temperature range of −49 degrees Celsius to 125 degrees Celsius and wherein the second mode is associated with a temperature range of −273 degrees Celsius to −49 degrees Celsius.

In some aspects, the techniques described herein relate to a method, wherein the first mode is associated with the condition measurements being above a condition threshold and wherein the second mode is associated with the condition measurements being below the condition threshold.

In some aspects, the techniques described herein relate to a method, wherein the condition measurements produced based on the first transformation have a first granularity, and wherein the condition measurements produced using the second transformation have a second granularity that is different than the first granularity.

In some aspects, the techniques described herein relate to a method, wherein the second granularity is less granular than the first granularity.

In some aspects, the techniques described herein relate to a method, wherein the condition measurements are one of: humidity measurements; light measurements; barometric-pressure measurements; vibration measurements; decibel measurements; air flow rate measurements; or fluid flow rate measurements.

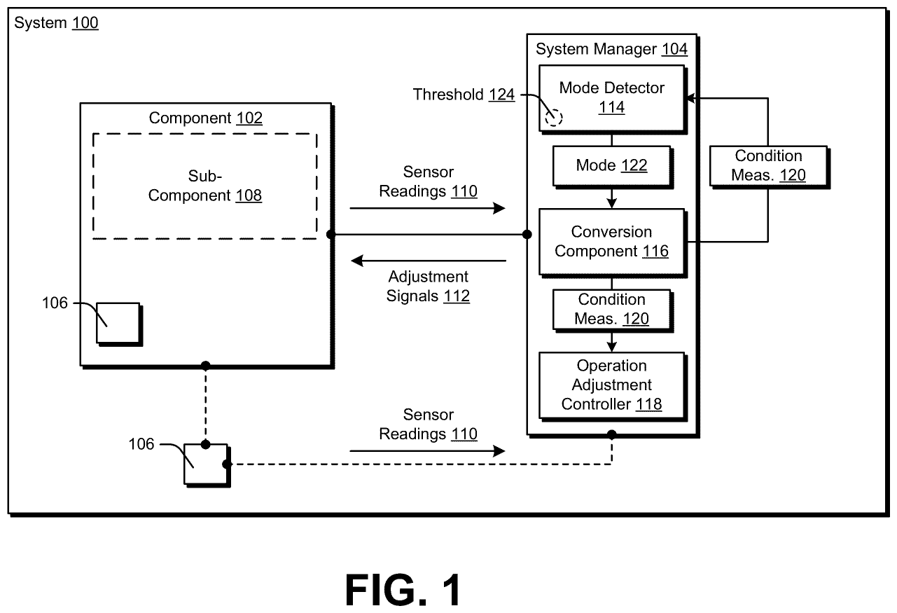

FIG. 1 is a block diagram of a non-limiting example system 100 having a system manager that is operable to implement dynamic range aware scaling of sensor readings. In this example, the system 100 includes a component 102, system manager 104, and one or more sensors 106. The component 102 optionally includes one or more sub-components 108.

Although the system manager 104 is depicted as separate from the component 102, in variations the system manager 104 (and/or various components of the system manager 104) are included as part of the component. In the illustrated example, the component 102 includes a sensor 106. The system 100 is also depicted having a sensor 106 that is remote from the component 102. In at least one variation, however, the sensors 106 used to produce condition measurements for the component 102 are all included as part of the component 102. In at least one other variation, the sensors 106 used to produce the condition measurements for the component are all remote from the component 102, e.g., proximate the component 102 and/or removably integral with the component 102 or a portion of the component 102. It is to be appreciated that in variations, the system 100 does not include one or more of the depicted components and/or includes different components without departing from the spirit or scope of the described techniques.

In accordance with the described techniques, the component 102 and the system manager 104 are coupled to one another via a wired or wireless connection. The sensor 106 that is depicted remote from the component 102 is also optionally coupled to the component 102 and/or the system manager 104 via one or more wired or wireless connections. The other components of the system 100 are connectable via wired and/or wireless connections. Example wired connections include, but are not limited to, buses (e.g., a data bus), interconnects, through silicon vias, traces, and planes. Examples of a device or apparatus in which the system 100 is implemented include, but are not limited to, servers, personal computers, laptops, desktops, game consoles, set top boxes, tablets, smartphones, mobile devices, virtual and/or augmented reality devices, wearables, medical devices, system-on-chip, and other computing devices, apparatuses, or systems.

Broadly, the component 102 is a portion of a computer architecture in relation to which a condition can be sensed (e.g., by one or more of the sensors 106) and for which the operation can be adjusted based on the sensed condition, e.g., to optimize and/or improve the operation for one or more performance considerations such as power usage, accuracy, and speed, to name a few. Examples of the component 102 include but are not limited to a printed circuit board (PCB) or other type of circuit board, a printed wiring board (PWB), a motherboard, a semiconductor, an integrated circuit, a microprocessor, one or more chips of semiconductor material (e.g., silicon), a communication system (e.g., a bus), and an interface between portions of a computing device. Thus, the portion of computer architecture to which the component 102 corresponds differs in variations without departing from the spirit or scope of the described techniques.

In one or more implementations, for instance, the component 102 is or includes a processor, examples of which include, but are not limited to, a central processing unit (CPU), a graphics processing unit (GPU), a field programmable gate array (FPGA), an accelerated processing unit (APU), and a digital signal processor (DSP). In at least one variation, the component 102 corresponds to or includes a single core processor. However, it at least one other variation, the component 102 corresponds to or includes a multi-core processor.

Alternatively or additionally, the component 102 is or includes a memory module, e.g., one or more circuit boards on which memory is mounted. In variations, for instance, one or more integrated circuits of memory are mounted on a circuit board of the memory module. Examples of a memory module include, but are not limited to, a TransFlash memory module, single in-line memory module (SIMM), and dual in-line memory module (DIMM). In one or more implementations, the component 102 is a memory module implemented as a single integrated circuit device that incorporates memory on a single chip or die. In one or more implementations, the component 102 is a memory module having multiple chips or dies that implement the memory, and the multiple chips or dies are vertically (“3D”) stacked together, placed side-by-side on an interposer or substrate, or assembled via a combination of vertical stacking or side-by-side placement.

Alternatively or additionally, the component 102 is or includes a memory, which is a device or system used to store information, such as for immediate use in a device, e.g., by a core of a processor and/or by a processing-in-memory component of the component 102 and/or communicably coupled to the component 102. In one or more implementations, the component 102 is memory implemented as semiconductor memory where data is stored within memory cells on one or more integrated circuits. In at least one example, for instance, component 102 corresponds to or includes volatile memory, examples of which include random-access memory (RAM), dynamic random-access memory (DRAM), synchronous dynamic random-access memory (SDRAM), and static random-access memory (SRAM). Alternatively or in addition, the component 102 corresponds to or includes non-volatile memory, examples of which include Ferro-electric RAM, Magneto-resistive RAM, flash memory, read-only memory (ROM), programmable read-only memory (PROM), erasable programmable read-only memory (EPROM), electronically erasable programmable read-only memory (EEPROM), and non-volatile dual in-line memory module (DIMM) (NVDIMM).

In one or more implementations, the component 102 is configured as a dual in-line memory module (DIMM). A DIMM includes a series of dynamic random-access memory integrated circuits, and the modules are mounted on a printed circuit board. Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the component 102 is configured as or includes a small outline DIMM (SO-DIMM) according to one of the above-mentioned SDRAM standards, e.g., DDR, DDR2, DDR3, DDR4, and DDR5. In one or more implementations, the component 102 is low-power double data rate (LPDDR) memory, also known as LPDDR SDRAM, and is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the component 102 is configurable in a variety of ways without departing from the spirit or scope of the described techniques.

As noted above, the component 102 optionally includes one or more sub-components 108. As used herein, a “sub-component” refers to a component included as part of, communicably coupled to, and/or otherwise accessible to the component 102 that is logically, communicably, and topographically considered “part of” the component 102. Where the component 102 is configured as a processing unit, for instance, examples of the sub-component 108 include, but are not limited to, a core or subset of cores of the processing unit, an intellectual property (IP) block, or another logic unit. Where the component 102 is configured as a memory module, for instance, examples of the sub-component 108 include, but are not limited to, an in-memory processor (e.g., a processing-in-memory component) and semiconductor memory where data is stored within memory cells on one or more integrated circuits. In variations where the component 102 does include at least one sub-component, the sub-components 108 can vary in accordance with the described techniques.

In accordance with the described techniques, the system manager 104 is configured to receive sensor readings 110, produced by one or more sensors 106, and control operation of the component 102 based on the sensor readings 110. In one or more implementations, the system manager 104, and/or one or more components accessible to the system manager 104, transmits one or more adjustment signals 112 to adjust at least one parameter (e.g., voltage, frequency, timings, etc.) with which the component 102 operates.

Broadly, the sensor readings 110 are produced and output by a sensor 106. As noted above, in one or more implementations, the system 100 includes at least one sensor 106 as part of the component 102 and at least one sensor 106 remote from the component 102 (but still capable of sensing one or more conditions and/or changes in one or more conditions associated with the component 102). In at least one variation, the component 102 includes all of the one or more sensors 106 used to sense one or more conditions and/or changes in one or more conditions associated with the component 102. In at least one other variation, all of the one or more sensors 106 used to sense one or more conditions and/or changes in one or more conditions associated with the component are remote from the component 102. In one or more implementations, at least one such “remote” sensor is proximate (in terms of location as part of the system) to the component 102.

In accordance with the described techniques, the system 100 includes one or more of various types of sensors 106. Examples of different types of sensors 106 include, but are not limited to, temperature sensors (e.g., thermal diodes), humidity sensors, barometric-pressure sensors, light sensors, image sensors, vibration sensors, noise (e.g., decibel) sensors, seismic sensors, air flow sensors, fluid flow sensors, accelerometers, gyroscopes, and analyte or chemical sensors. In variations, the sensor 106 is configured as one or more of these and/or different types of sensors without departing from the spirit or scope of the described techniques.

The one or more sensors 106 produce the sensor readings 110 and communicate (e.g., transmit) the sensor readings 110 to the system manager 104 (or the sensor readings 110 are transmitted to the system manager 104 on behalf of a sensor 106. In one example, for instance, sensor readings 110 from a sensor 106 that is included as part of the component 102 are communicated from the component 102 to the system manager 104 across a communicative coupling (e.g., an interface) between the component 102 and the system manager 104. In one or more implementations, the adjustment signals 112 are communicated (or transmitted) across the same or a different communicative coupling (e.g., interface) to adjust the operation of the component 102. In one example where the sensor readings 110 are from a sensor 106 that is remote from the component 102, the sensor readings 110 are communicated across a first communicative coupling between the sensor 106 and the component 102, and then across a second communicative coupling between the component 102 and the system manager 104. In a different example where the sensor readings 110 are from a sensor that is remote from the component 102, the sensor readings 110 are communicated across a communicative coupling between the sensor 106 and the system manager 104 (e.g., bypassing the component 102). In the illustrated example, the communicative couplings depicted for the sensor 106 remote from the component 102 are illustrated with dashed lines to indicate that they are optional, although the inclusion of the remote sensor 106 is optional also.

As discussed above and below, the system manager 104 includes interfaces and logic to receive the sensor readings 110 and process them to adjust operation of the component 102 based on the sensor readings 110. In one or more implementations, the system manager 104 is implemented, at least in part, in firmware. Alternatively or additionally, the system manager 104 is implemented in hardware and/or software. In one or more implementations, the system manager 104 is configured as a microcontroller disposed on a die running firmware to perform a variety of the operations discussed above and below. Examples of the system manager 104 include but are not limited to a system management unit (SMU), a power management unit (PMU), and system management controller (SMC). In the illustrated example, the system manager 104 includes mode detector 114, conversion component 116, and operation adjustment controller 118. It is to be appreciated that in variations, the system manager 104 includes more, fewer, or different components without departing from the spirit or scope of the described techniques.

In accordance with the described techniques, the conversion component 116 converts the sensor readings 110 to condition measurements 120. For example, the conversion component 116 converts sensor readings of voltages produced by a thermal diode (an example of a sensor 106) to temperature measurements (an example of condition measurements 120). Moreover, the conversion component 116 converts the sensor readings 110 into the condition measurements 120 based on a mode 122. With reference again to the temperature measurements, for instance, the conversion component 116 converts the sensor readings 110 into the temperature measurements using a first granularity while operating in a first conversion mode, and the conversion component 116 converts the sensor readings 110 into the temperature measurements using a second granularity while operating in a second conversion mode. By way of example, the conversion component 116 uses the first granularity while operating in a first conversion mode that is associated with a first temperature range (e.g., approximately −49 degrees Celsius to approximately 125 degrees Celsius) and uses the second granularity while operating in a second conversion mode that is associated with a second temperature range (e.g., approximately −273 degrees Celsius to approximately −49 degrees Celsius). Thus, the system manager 104 and/or its components operate according to at least two modes, and in at least one variation the system manager 104 and/or its components operate according to more than two modes, e.g., in connection with three or more ranges of condition measurements 120.

The condition measurements 120 depend, at least in part, on a type of sensor 106 that produces the sensor readings 110 from which the condition measurements 120 are derived. In one or more implementations, for instance, the condition measurements 120 are limited by the conditions and/or changes in conditions which a sensor 106 is capable of sensing. Although many of the examples discussed in detail herein relate to temperature measurements, the described techniques are applicable to measurements produced for a variety of conditions. Examples of the condition measurements 120 include but are not limited to temperature measurements, humidity measurements, barometric-pressure measurements, light measurements, measurements produced from images, vibration measurements, decibel measurements, seismic measurements, air flow (and/or air flow rate) measurements, fluid flow (and/or fluid flow rate) measurements, accelerometer data, gyroscope data, and analyte or chemical measurements. In variations, the conversion component 116 is configured to produce different types of measurements 120 without departing from the spirit or scope of the described techniques.

In conventional approaches, system managers limit the condition measurements that are produced from sensor readings. By default for example, some conventional systems limit the temperature measurements that are produced from the output of thermal diodes (e.g., temperature sensors) to a range of approximately −49 degrees Celsius to 125 degrees Celsius. This is at least partially because those sensors lack the fidelity produce sensor readings that are as accurate for relatively low temperatures (e.g., −150 degrees Celsius) as they are for higher temperatures—at very low temperatures the voltage readings produced by thermal diodes can correspond to small values (numerous leading zeroes) which can change significantly due to relatively minor fluctuations in temperature. Due to this, conventional systems “cap” measurements below a lower threshold of a default range, e.g., −49 degrees Celsius. Those conventional systems treat temperatures below the cap in a same manner. For instance, conventional systems that are capped at −49 degrees Celsius handle system adjustments for −50 degrees Celsius and −150 degrees Celsius the same way. By way of example, these conventional systems adjust component operating parameters (e.g., voltage, frequency, timings, etc.) the same way at −50 degrees Celsius and at −150 degrees Celsius. Without adjusting operation of the components differently at different temperatures outside the default range, conventional approaches fail to take advantage of performance improvements or optimizations which would be available if the operation of those components were adjusted based on the actual temperatures.

In contrast to conventional techniques, in one or more implementations, the system manager 104 does not treat condition measurements (e.g., temperatures) outside a default range in a same manner. In at least one variation, for instance, the system manager 104 does not handle system adjustments for −50 degrees Celsius and −150 degrees Celsius the same way. Rather than cap the condition measurements 120 at the bounds of a default range, in one or more implementations, the conversion component 116 converts the sensor readings 110 differently when the condition measurements 120 are outside (e.g., below) a default range.

In at least one implementation, for instance, the conversion component 116 converts the sensor readings 110 to the condition measurements 120 using a first transformation (e.g., algorithm) for a first range (e.g., a default range) of the condition measurements 120. The condition measurements 120 produced by the conversion component 116 based on the first transformation have a first granularity. As an example, the condition measurements 120 produced based on the first transformation measure the condition out to two decimal places of a unit. For a second range of the condition measurements 120, the conversion component 116 converts the sensor readings 110 to the condition measurements 120 using a second transformation (e.g., algorithm). The condition measurements 120 produced by the conversion component 116 based on the second transformation have a second granularity. As an example, the condition measurements 120 produced based on the second transformation measure the condition at an increment number of the units (e.g., at 8-, 10-, or 16-unit increments). In one or more variations, the second granularity is less granular than the first granularity. Alternatively, the second granularity is more granular than the first granularity.

Broadly, the conversion component 116 converts the sensor readings 110 using a first transformation while operating in a first conversion mode and converts the sensor readings 110 using a second transformation while operating in a second conversion mode. In at least one implementation, there are more than two conversion modes, e.g., three or more. Each conversion mode is associated with a transformation used by the conversion component 116 to convert the sensor readings 110 to the condition measurements 120 while operating in that conversion mode. At least two of the conversion modes are associated with different transformations, e.g., a first conversion mode is associated with a first transformation and a second conversion mode is associated with a second transformation that is different from the first transformation. In scenarios where there are more than two conversion modes, in at least one variation, an additional (e.g., third) conversion mode is associated with a different (e.g., third) transformation than the first and second conversion modes; however, in at least one other variation, an additional (e.g., third) conversion mode is associated with a same transformation as one of the first or the second conversion modes.

In variations, the transformation used by the conversion component 116 to convert the sensor readings 110 to the condition measurements 120 while in a respective conversion mode includes one or more of a variety of operations applied to the sensor readings 110. Examples of those operations include, but are not limited to, adding an amount to the sensor readings 110 subtracting an amount from the sensor readings 110, multiplying the sensor readings 110 by an amount, dividing the sensor readings 110 by an amount, performing a bit shift on the sensor readings 110, amplifying the sensor readings 110, scaling the sensor readings, and applying one or more logical operators to the sensor readings 110, to name just a few. In variations, the conversion component 116 performs combinations of one or more of the above-noted operations and/or different operations in connection with a particular transformation to convert the sensor readings 110 to the condition measurements 120 while operating in a respective conversion mode.

In short, the conversion component 116 obtains the sensor readings 110 (e.g., as input) and outputs the condition measurements 120. Here, the conversion component 116 is depicted outputting the condition measurements 120 to the mode detector 114 and the operation adjustment controller 118. Although the mode detector 114 is depicted separate from the conversion component 116 in the illustrated example, in one or more implementations, the mode detector 114 is included as part of or otherwise accessible to the conversion component 116.

Broadly, the mode detector 114 outputs the mode 122 (of a plurality of conversion modes) based on the condition measurements 120. For instance, the mode detector 114 outputs the mode 122 as a first conversion mode when the condition measurements 120 are in a first range and the mode detector 114 outputs the mode 122 as a second conversion mode when the condition measurements 120 are with a second range. In variations, the ranges associated with different modes are non-overlapping. By way of example, a first mode is associated with a first range of −49≤x<125 degrees Celsius, and a second mode is associated with a second range of −273<x<−49 degrees Celsius. Alternatively, the ranges associated with different modes are partially overlapping or completely overlapping. As an example of partially overlapping ranges, a first mode is associated with a first range of −48≤x<125 degrees Celsius, and a second mode is associated with a second range of −273≤x<−50 degrees Celsius. As an example of a completely overlapping ranges, a first mode is associated with a first range of −49≤x<125 degrees Celsius, and a second mode is associated with a second range of −256≤x≤256 degrees Celsius.

In implementations that include completely overlapping ranges, the portions of the second range outside the first range can be associated with a same transformation. In this way, when the condition measurements are above the first range and when the condition measurements are below the first range (but within the second range) the conversion component 116 converts the sensor readings 110 using a same transformation (e.g., the second transformation), which results in the conversion component 116 producing condition measurements 120 above and below the first range with a same granularity, whereas the condition measurements 120 produced by the conversion component 116 within the first range have a different granularity.

In one or more implementations, the mode detector 114 determines the mode 122 based on a threshold 124, e.g., a threshold condition measurement. For instance, the mode detector 114 determines to switch from a first conversion mode to a second conversion mode based on satisfying the threshold 124. Notably, as the condition measurements 120 approach an end of a range from one direction, in implementations, the threshold 124 corresponds to a different condition measurement than when the condition measurements 120 approach the end of the range from the opposite direction, e.g., there is more than one threshold 124 based on which modes are switched.

By way of example, consider a scenario in which a first conversion mode is associated with a range from range of −49≤x<125 degrees Celsius and in which a second conversion mode is associated with a second range of −256≤x<256 degrees Celsius. Consider also that in this scenario the sensor readings 110 received are converted to condition measurements 120 (e.g., temperature measurements) which are proximate to (e.g., −47 degrees Celsius) and continuing to drop toward −49 degrees Celsius. In at least one variation, the mode detector 114 outputs the first conversion mode as the mode 122 at this time, so that the conversion component 116 converts the sensor readings 110 using a first transformation. Consider also in this example, that the threshold for switching from the first to the second conversion modes is −48 degrees Celsius, such that if the mode detector 114 receives a condition measurement 120 while operating in the first conversion mode that is less than or equal to −48 degrees Celsius, the mode detector 114 initiates a switch to the second conversion mode, e.g., the mode detector 114 outputs the second conversion mode as the mode 122, so that the conversion component 116 subsequently converts the sensor readings 110 using a second transformation.

Continuing with this scenario, consider that subsequent to switching to the second conversion mode, sensor readings 110 are received that are converted to condition measurements 120 (e.g., temperature measurements) which are proximate to (e.g., −50 degrees Celsius) and continuing to rise toward −49 degrees Celsius. As noted above, the mode detector 114 outputs the second conversion mode as the mode 122 at this time, so that the conversion component 116 converts the sensor readings 110 using the second transformation. Consider that in this example, the threshold for switching back from the second conversion mode to the first conversion mode is −50 degrees Celsius, such that if the mode detector 114 receives a condition measurement 120 while operating in the second conversion mode that is greater than or equal to −50 degrees Celsius, the mode detector 114 initiates a switch back to the first conversion mode, e.g., the mode detector 114 outputs the first conversion mode as the mode 122, so that the conversion component 116 subsequently converts the sensor readings 110 using the first transformation. Notably, in this example, the thresholds for mode switching between a first and second mode are different, e.g., depending on a direction the range associated with the next mode is approached. In one or more implementations, this overlap, and the use of the multiple thresholds, prevents the conversion component 116 from receiving a sensor reading that cannot be converted to a condition measurement.

In one or more implementations, the condition measurements 120 produced by the conversion component 116 that are outside of a first range are less granular than the condition measurements 120 produced by the conversion component 116 that are within the first range. As a tradeoff to the granularity, though, the system manager 104 is able to extend a range that is covered by the condition measurements 120 outside the first range. Rather than being able to produce condition measurements at hundredth-of-a-unit increments as the system manager 104 does inside a smaller range, for instance, the system manager 104 is limited to producing condition measurements at x-number-of-unit increments for a larger range that extends beyond the smaller range in at least one direction. Thus, the described techniques extend condition measurement coverage beyond the ranges covered by conventional techniques, such as by sacrificing precision in the extended ranges. Advantageously, this enables the system manager 104 to continue adjusting operation of system components dynamically as conditions change within the extended ranges. As a result, the system manager 104 is able to improve and/or optimize operation of the system 100's one or more components 102 when operating in more extreme conditions that are covered by the extended ranges.

As noted above, the system manager 104 includes the operation adjustment controller 118. Although the operation adjustment controller 118 is depicted as included as part of the system manager 104 in this example, in one or more implementations, the operation adjustment controller 118 is separate from the system manager 104 and the system manager 104 is configured to interface with the operation adjustment controller 118. Broadly, the operation adjustment controller 118 is configured to update operation of various components of the system 100, such as operation of the component 102, based on the condition measurements 120. In accordance with the described techniques, the operation adjustment controller 118 communicates (e.g., transmits or initiates transmission of) the adjustment signals 112 to adjust one or more parameters (e.g., voltage, frequency, timings, etc.) with which the component 102 operates. For instance, the operation adjustment controller 118 provides the adjustment signals 112 to adjust operation of the component 102 for different condition measurements within a first range, e.g., to optimize and/or improve the operation for one or more performance considerations such as power usage, accuracy, and speed, to name a few. Further, and in contrast to conventional techniques, the operation adjustment controller 118 provides the adjustment signals 112 to adjust operation of the component 102 for different condition measurements within a second range, e.g., in an extended range outside of the first range. In this way, the operation adjustment controller 118 continues to optimize and/or improve the operation of the component 102 dynamically for one or more performance considerations such as power usage, accuracy, and speed, when operating conditions change outside the first range. This contrasts with conventional approaches which statically set operation of components when the conditions in which they operate extend beyond default ranges.

In one or more implementations, the operation adjustment controller 118 corresponds to or is otherwise configured to interface with one or more systems such as an adaptive voltage scaling (AVS) system, an adaptive voltage frequency scaling (AVFS), and a dynamic voltage frequency system (DVFS). In at least one variation, the operation adjustment controller 118 uses such systems to adjust parameters (e.g., voltage, frequency, timings, etc.) with which the component 102 operates based on the condition measurements 120.

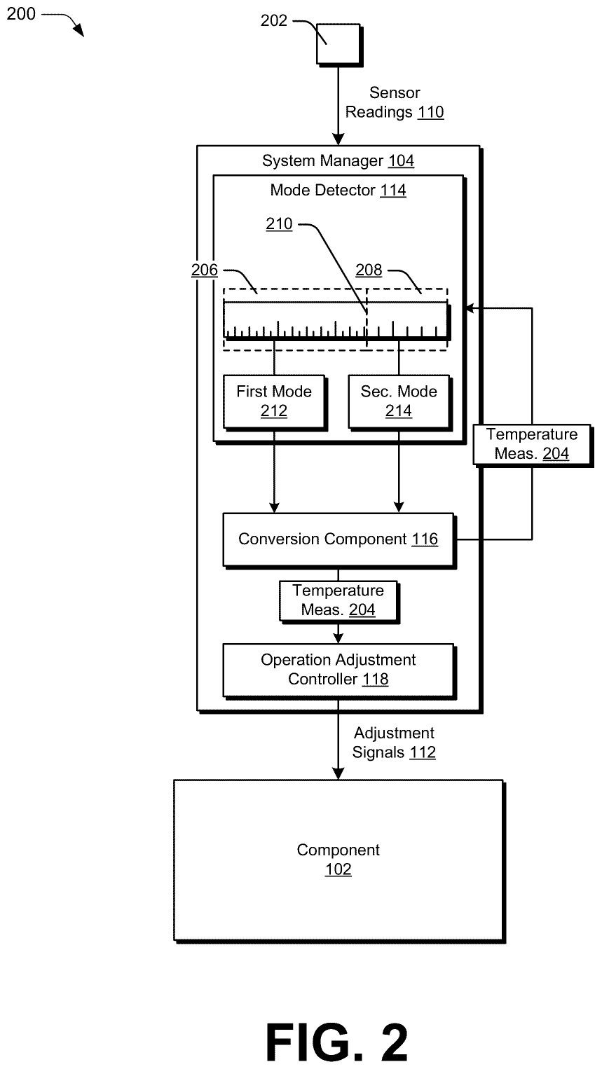

In accordance with the described techniques, for instance, the operation adjustment controller 118 is configured to adjust operation of the component 102 dynamically based on the condition measurements 120, such as by communicating an adjustment signal 112 to adjust a frequency, voltage, and/or timings at which the component 102 operates. In the context of a temperature-specific example, consider the following discussion of FIG. 2.

FIG. 2 is a block diagram of a non-limiting example 200 in which sensor readings from a temperature sensor are converted dynamically based on first and second temperature ranges.

The illustrated example 200 includes the system manager 104, the mode detector 114, the conversion component 116, the operation adjustment controller 118, and the component 102. This example 200 also includes a temperature sensor 202, an example of which is a thermal diode. In accordance with the described techniques, the temperature sensor 202 senses at least one condition and/or a change in the at least one condition associated with the component 102, e.g., a condition in which the component 102 operates. In variations, the temperature sensor 202 is included as part of the component 102, and in other variations the temperature sensor 202 is separate from the component 102.

Here, the system manager 104 is depicted receiving sensor readings 110 from the temperature sensor 202, e.g., voltage readings. In accordance with the described techniques, the conversion component 116 converts the sensor readings 110 to temperature measurements 204. For example, the conversion component 116 converts voltage readings received from the temperature sensor 202 over time to the temperature measurements 204. As discussed above and below, the conversion component 116 converts the sensor readings 110 to the temperature measurements 204 based on a current mode of a plurality of conversion modes. For instance, the conversion component 116 converts the sensor readings 110 differently (e.g., using different transformations or algorithms) for at least two of the conversion modes.

The illustrated example 200 includes a first temperature range 206 and a second temperature range 208. The first temperature range 206 switches to the second temperature range 208 at a threshold temperature measurement 210. In this example 200, the first temperature range 206 is associated with a first mode 212 and the second temperature range 208 is associated with a second mode 214. As noted above, in variations, the mode detector 114 switches from the first mode 212 to the second mode 214 at a different threshold temperature measurement 210 than the mode detector 114 switches from the second mode 214 to the first mode 212. Alternatively, the mode detector 114 switches between the first mode 212 and the second mode 214 based satisfying a same threshold. The mode detector 114 provides an indication (e.g., a signal) of the first mode 212 or the second mode 214 to the conversion component 116 based on the temperature measurements 204.

The conversion component 116 converts the sensor readings 110 to the temperature measurements 204 based on the indicated (or signaled) mode. In accordance with the described techniques, for instance, while in the first mode 212 the conversion component 116 converts the sensor readings 110 from the temperature sensor 202 using a first transformation. While in the second mode 214, though, the conversion component 116 converts the sensor readings 110 from the temperature sensor 202 using a second transformation, which is different from the first transformation.

In the context of this example 200, consider a variation in which the first temperature range 206 is −49≤x<125 degrees Celsius, the second temperature range 208 is −273≤x<−49 degrees Celsius, and the threshold is −49 degrees Celsius. Accordingly, the first mode 212 is associated with the temperature range of −49≤x<125 degrees Celsius and the second mode is associated with the temperature range of −273≤x<−49 degrees Celsius. Since the conversion component 116 uses a first transformation while operating in the first mode 212, the conversion component 116 uses the first transformation for temperature measurements 204 approximately within the range of −49≤x<125. Also, since the conversion component 116 uses a second transformation while operating in the second mode 214, the conversion component 116 uses the second transformation for temperature measurements 204 approximately within the range of −273≤x<−49.

In one or more implementations, the first transformation and the second transformation cause the conversion component 116 to produce temperature measurements 204 having different granularities. In one variation, for example, the first transformation associated with the first temperature range 206 causes the conversion component 116 to produce temperature measurements 204 that are more granular than the temperature measurements 204 produced by using the second transformation. Thus, the second transformation associated with the second temperature range 208 causes the conversion component 116 to produce temperature measurements 204 that are less granular than the temperature measurements 204 produced by using the first transformation. In at least one variation, the second transformation used in the second mode 214 is configured to produce less granular temperature measurements 204 than the first transformation used in the first mode 212, e.g., every x-degrees Celsius (less granular) versus every hundredth of a degree Celsius (more granular). Certainly, an amount of granularity differs in variations, e.g., depending on a sensitivity of a sensor and/or bandwidth or processing considerations. However, the second transformation is usable to accurately produce temperature measurements 204 for a wider range of temperatures (although with less “precision” or “granularity”) than the first transformation, e.g., −256≤x<256 versus −49≤x<125.

By continuing to provide temperature measurements 204 for changing temperatures outside of a default temperature range (e.g., the first temperature range 206), the conversion component 116 enables the operation adjustment controller 118 to dynamically adjust operation of the component 102 for different temperatures outside of the default temperature range, e.g., for two or more different temperatures within an extended temperature range. In this way, the operation adjustment controller 118 continues to optimize and/or improve the operation of the component 102 dynamically for one or more performance considerations such as power usage, accuracy, and speed, even when the component 102 is subject to changing conditions within the second temperature range 208. This contrasts with conventional approaches which statically set operation of components when the conditions in which they operate extend beyond default ranges.

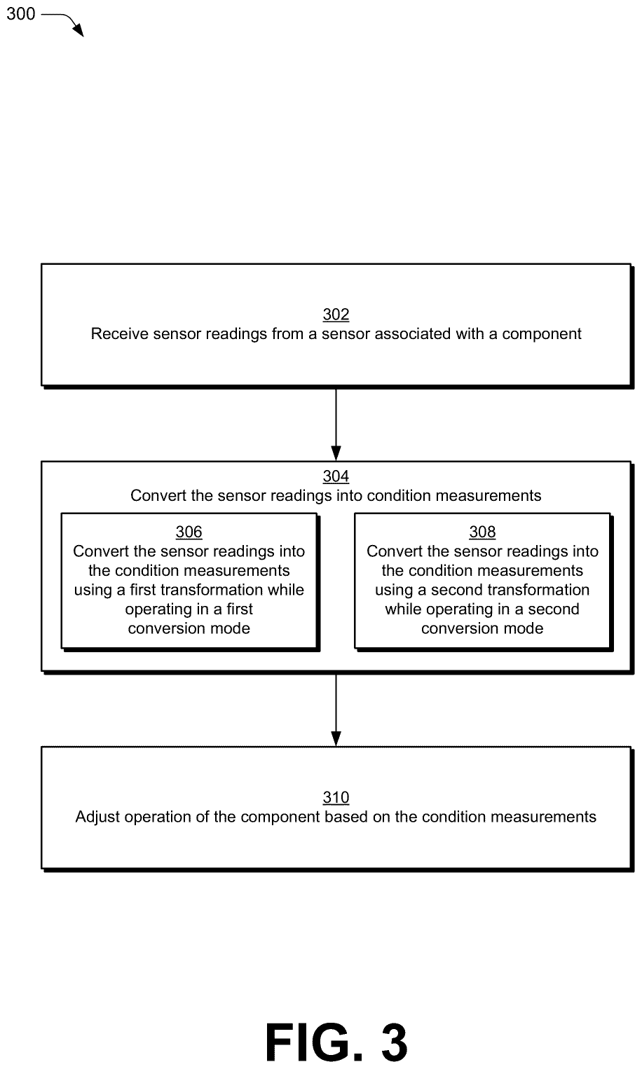

FIG. 3 depicts a procedure in an example 300 implementation of dynamic range aware conversion of sensor readings.

Sensor readings are received from a sensor associated with a component (block 302). By way of example, the system manager 104 receives sensor readings 110, produced by one or more sensors 106. Broadly, the sensor readings 110 are produced and output by a sensor 106. As noted above, in one or more implementations, the system 100 includes at least one sensor 106 as part of the component 102 and at least one sensor 106 remote from the component 102 (but still capable of sensing one or more conditions and/or changes in one or more conditions associated with the component 102). In at least one variation, the component 102 includes all of the one or more sensors 106 used to sense one or more conditions and/or changes in one or more conditions associated with the component 102. In at least one other variation, all of the one or more sensors 106 used to sense one or more conditions and/or changes in one or more conditions associated with the component are remote from the component 102. In one or more implementations, at least one such “remote” sensor is proximate (in terms of location as part of the system) to the component 102. The sensor readings 110 may be received from a variety of different types of sensors 106. Examples of different types of sensors 106 include, but are not limited to, temperature sensors (e.g., thermal diodes), humidity sensors, barometric-pressure sensors, light sensors, image sensors, vibration sensors, noise (e.g., decibel) sensors, seismic sensors, air flow sensors, fluid flow sensors, accelerometers, gyroscopes, and analyte or chemical sensors.

The sensor readings are converted into condition measurements (block 304). In accordance with the principles discussed herein, converting the sensor readings into condition measurements includes converting the sensor readings into the condition measurements using a first transformation while operating in a first conversion mode (block 306) or converting the sensor readings into the condition measurements using a second transformation while operating in a second conversion mode (block 308). By way of example, the conversion component 116 converts the sensor readings 110 into condition measurements 120 using a first transformation while operating in a first conversion mode and converts the sensor readings 110 into condition measurements 120 using a second transformation while operating in a second conversion mode. In one or more implementations, the first conversion mode is associated with a range (e.g., a default range) of the condition measurements 120, while the second conversion mode is associated with a second range of the condition measurements 120. In one or more implementations, the condition measurements 120 produced by the conversion component 116 based on the first transformation have a first granularity, while the condition measurements 120 produced by the conversion component 116 based on the second transformation have a second granularity.

Operation of the component is adjusted based on the condition measurements (block 310). By way of example, the operation adjustment controller 118 adjusts operation of various components of the system 100, such as operation of the component 102, based on the condition measurements 120. In accordance with the described techniques, the operation adjustment controller 118 communicates (e.g., transmits or initiates transmission of) the adjustment signals 112 to adjust one or more parameters (e.g., voltage, frequency, timings, etc.) with which the component 102 operates. For instance, the operation adjustment controller 118 provides the adjustment signals 112 to adjust operation of the component 102 for different condition measurements within a first range, e.g., to optimize and/or improve the operation for one or more performance considerations such as power usage, accuracy, and speed, to name a few. Further, and in contrast to conventional techniques, the operation adjustment controller 118 provides the adjustment signals 112 to adjust operation of the component 102 for different condition measurements within a second range, e.g., in an extended range outside of the first range. In this way, the operation adjustment controller 118 continues to optimize and/or improve the operation of the component 102 dynamically for one or more performance considerations such as power usage, accuracy, and speed, when operating conditions change outside the first range. This contrasts with conventional approaches which statically set operation of components when the conditions in which they operate extend beyond default ranges.

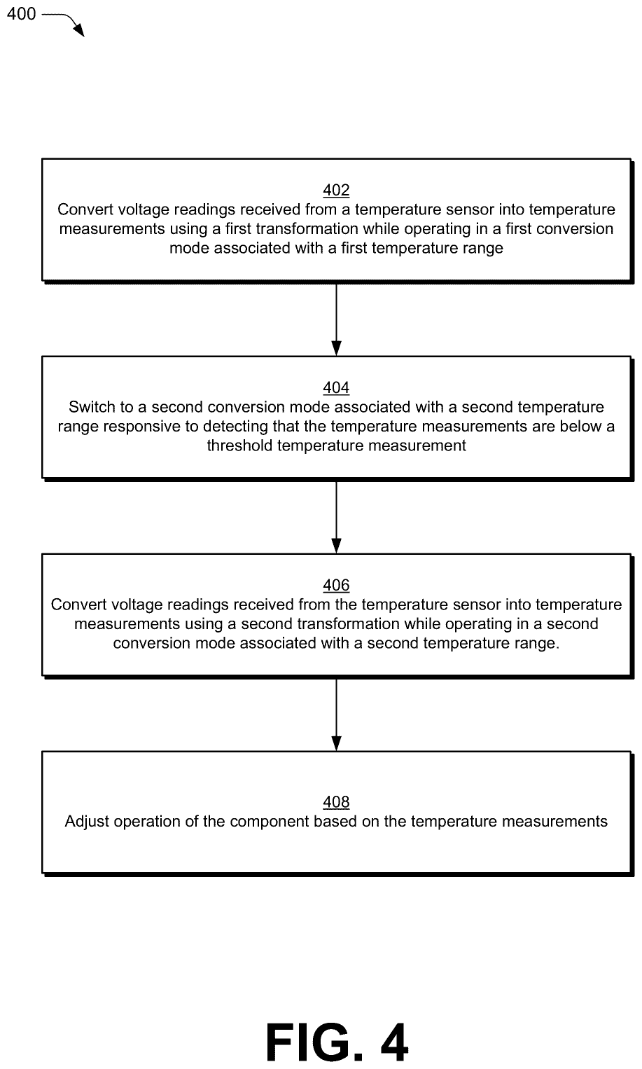

FIG. 4 depicts a procedure in an example 400 implementation of dynamic temperature range aware conversion of sensor readings.

Voltage readings received from a temperature sensor are converted into temperature measurements using a first transformation while operating in a first conversion mode associated with a first temperature range (block 402). By way of example, the conversion component 116 converts voltage readings received from the temperature sensor 202 over time to the temperature measurements 204 using a first transformation while operating in the first mode 212.

A second conversion mode associated with a second temperature range is switched to responsive to detecting that the temperature measurements are below a threshold temperature measurement (block 404). By way of example, the mode detector 114 switches from the first mode 212 to the second mode 214 responsive to detecting that the temperature measurements 204 are below a threshold temperature measurement 210.

Voltage readings received from the temperature sensor are converted into temperature measurements using a second transformation while operating in a second conversion mode associated with a second temperature range (block 406). By way of example, the conversion component 116 converts voltage readings received from the temperature sensor 202 over time to the temperature measurements 204 using a second transformation while operating in the second mode 214.

Operation of the component is adjusted based on the temperature measurements (block 408). By way of example, the operation adjustment controller 118 adjusts operation of the component 102 based on the temperature measurements 204.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the component 102 and the system manager 104) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
one or more sensors to sense conditions of a component and output sensor readings; and
a system manager to:
convert the sensor readings into condition measurements using a first transformation while operating in a first conversion mode or using a second transformation while operating in a second conversion mode; and
adjust operation of the component based on the condition measurements.

2. The system of claim 1, wherein the one or more sensors include one or more thermal diodes.

3. The system of claim 1, wherein the condition measurements are one of:
temperature measurements;
humidity measurements;
light measurements;
barometric-pressure measurements;
vibration measurements;
decibel measurements;
air flow rate measurements; or
fluid flow rate measurements.

4. The system of claim 1, wherein the first mode is associated with a temperature range above −49 degrees Celsius and wherein the second mode is associated with a temperature range below −49 degrees Celsius.

5. The system of claim 1, wherein the first mode is associated with the condition measurements being above a condition threshold, and wherein the second mode is associated with the condition measurements being below the condition threshold.

6. The system of claim 5, wherein the system manager is further configured to switch from the first conversion mode to the second conversion mode responsive to detecting that the condition measurements are below the condition threshold.

7. The system of claim 5, wherein the condition measurements produced based on the first transformation have a first granularity, and wherein the condition measurements produced using the second transformation have a second granularity that is different than the first granularity.

8. The system of claim 7, wherein the second granularity is less granular than the first granularity.

9. An apparatus comprising:
a component;
a temperature sensor; and
a system manager to:
convert voltage readings received from the temperature sensor into temperature measurements using a first transformation while operating in a first conversion mode associated with a first temperature range;
switch to a second conversion mode associated with a second temperature range responsive to detecting that the temperature measurements are below a threshold temperature measurement;
convert voltage readings received from the temperature sensor into temperature measurements using a second transformation while operating in a second conversion mode associated with a second temperature range; and
adjust operation of the component based on the temperature measurements.

10. The apparatus of claim 9, wherein the first transformation and the second transformation cause the system manager to produce temperature measurements having different granularities.

11. The apparatus of claim 10, wherein the temperature measurements produced while operating in the second conversion mode are less granular than the temperature measurements produced while operating in the first conversion mode.

12. The apparatus of claim 9, wherein the temperature sensor comprises a thermal diode.

13. A method comprising:
receiving sensor readings from a sensor associated with a component;
converting the sensor readings into condition measurements using a first transformation while operating in a first conversion mode or using a second transformation while operating in a second conversion mode; and
adjusting operation of the component based on the condition measurements.

14. The method of claim 13, wherein the sensor is a thermal diode.

15. The method of claim 13, wherein the condition measurements are one of:
temperature measurements;
humidity measurements;
light measurements;
barometric-pressure measurements;
vibration measurements;
decibel measurements;
air flow rate measurements; or
fluid flow rate measurements.

16. The method of claim 13, wherein the first mode is associated with a temperature range above −49 degrees Celsius and wherein the second mode is associated with a temperature range below −49 degrees Celsius.

17. The method of claim 13, wherein the first mode is associated with the condition measurements being above a condition threshold and wherein the second mode is associated with the condition measurements being below the condition threshold.

18. The method of claim 17, further comprising switching from the first conversion mode to the second conversion mode responsive to detecting that the condition measurements are below the threshold condition measurement.

19. The method of claim 17, wherein the condition measurements produced based on the first transformation have a first granularity, and wherein the condition measurements produced using the second transformation have a second granularity that is different than the first granularity.

20. The method of claim 19, wherein the second granularity is less granular than the first granularity.
